(19) United States
(12) Patent Application Publication
(10) Pub. No.: US 2019/0055659 A1
(43) Pub. Date: Feb. 21, 2019

(54) Marine Water Electrolysis System

(71) Applicant: Kraftpowercon Inc. USA, Fairfield, CT (US)

(72) Inventors: Peter Mathisson, Gothenburg (SE); Göran Stenmark, Gothenburg (SE); Vijay Jakkli, Pondicherry (IN)

(21) Appl. No.: 15/681,667

(22) Filed: Aug. 21, 2017

(51) Int. Cl. C25B 15/02; C25B 1/04; B63J 4/00

(52) U.S. Cl. CPC C25B 15/02; H02J 1/00; B63J 4/002; C25B 1/04

(57) ABSTRACT

A power supply for a marine water electrolysis system has a control module and at least one power module in communication with the control module. The power module has a first rectifier sub-module and a second rectifier sub-module, where each of the rectifier sub-modules has a current output to an electrolyzer. The power supply has a microcontroller which provides instructions to the at least one power module to provide a specified DC voltage and DC current to the electrolyzer. The sub-modules may be identical, with each sub-module capable of independent operation (at different voltage and current levels). Any number of power modules can be connected in series or in parallel to match the DC voltage and DC current requirements of the electrolyzer. The sub-modules may be stacked in a tower configuration within a rack. Any one or more power modules may be removed from the rack independent of the remaining power modules within the rack without interrupting operation of the electrolyzer.

### BACKGROUND OF THE INVENTION

Ballast water is carried in ships to provide stability and trim. A ship's ability to take on and discharge ballast water is fundamental to its safe operation. As a ship loads or unloads cargo or takes on or consumes fuel, the ship must accommodate changes to its displacement and trim by taking on or discharging ballast water. Ballast water is taken on through openings near or on the bottom of a ship's hull and is pumped in or out of a ship through piping connected to ballast pumps which are located in the ship's lower machinery space. Without these ballast water operations, ships cannot be operated safely: ballast water intake and discharge provides proper stability and trim, minimizes hull stress, aids or allows maneuvering, and reduces ship motions of roll and pitch. The water pumped into a ship's ballast tanks must inevitably be pumped out when the ship takes on cargo. Ballast uptake and discharge most often occurs in port during cargo operations, but may also occur while the ship is in transit on the open sea or through connecting waterways to maintain proper trim and stability.

One drawback to the explosive growth of marine vessel transport is undesirable aquatic nuisance species—both aquatic plant and aquatic animal species—can be carried within a vessel's ballast water and be inadvertently transported across the world and discharged into the waters of a particular region, threatening the diversity or abundance of native species and threaten the ecological stability of the waters.

Because of the environmental harm caused by aquatic nuisance species, governing bodies around the world have imposed rules and regulations which require shipping operators to utilize ballast water treatment systems prior to discharge of any ballast water from a vessel. For example, the United States Environmental Protection Agency has issued a final vessel general permit (VGP) which regulates vessel discharges from commercial vessels, which includes ballast water to protect the nation's waters from ship-borne pollutants and to reduce invasive species in U.S. waters.

A variety of technologies are available for ballast water treatment systems. However, constraints such as availability of space, cost of implementation, and the level of effectiveness impact the selection of a particular system. The main types of systems currently used are physical filtration, chemical disinfection, ultra-violet treatment, deoxygenation treatment, thermal treatment, cavitation treatment, and electric pulse treatment. The physical filtration systems commonly used for ballast water treatment include screen filtration and hydrocyclones. However, most of the physical filtration systems are not able to remove the smaller particulate solids. Because of this limitation, electrolysis is frequently used prior to the filtration process to treat the ballast water

The devices utilizing electrolysis employ an electrolytic reaction by causing ballast water to pass through an electrolytic cell with the water coming into contact with electrode plates or electrodes inside the electrolytic cell. This electrolytic cell is referred to as an electrolyzer. A power supply, in conjunction with a rectifier, provides current to the electrodes of the electrolyzer through cables and bus bars.

It is to be appreciated that the marine environment—which includes continuous accelerations and corrosive sea air—provides significant challenges to the reliability of sensitive electrical components, subjecting the devices to severe service which promotes failure. Unfortunately, a failure in the power supply will cause the electrolyzer to cease operating, resulting in either the discharge of water contaminated with pollutants and invasive species, or in the inability of the vessel to discharge ballast water, thus making it unacceptable for transport of cargo.

Incoming ports typically rely upon the vessel's compliance with a ship-specific ballast water management plan. The vessels are also required to be surveyed and certified, and may be inspected by port control officers. If there are concerns a detailed inspection may be carried out and discharge prohibited until such steps are taken to ensure that the vessel will not discharge ballast water until it can do so without presenting a threat of harm to the environment, human health, property or resources. However, these measures are only employed when the concerns are identified.

### SUMMARY OF THE INVENTION

Embodiments of the present invention answer the above-identified need by providing a power supply for a marine water electrolysis system which provides redundancy, reliability, ease of repair, and the capability of delivering operational status reports both locally and remotely. The power supply has a control module and at least one power module.

Embodiments of the disclosed power supply may be truly modular, where the system may function even in the event of a failure of a power module. This feature of the invention provides redundancy and facilitates maintenance and repair. Even if a power module fails, the system continues to operate at reduced power. The faulty power module may be easily replaced. The system may also be easily expanded by installing additional power modules to accommodate the need for additional water processing capacity. The communication capabilities of embodiments of the invention allow remote access to the status of the system through a controller area network (CAN). This feature allows a destination port to verify the operation of the ballast water treatment system while the vessel is in route to the port.

The power supply is configured to the electrical grid conditions on board the vessel, and may utilize a variety of supply voltages (220-240 VAC, 380-480 VAC, 50/60 Hz). The power system is suitable for TN-S, TN-C, IT and TT electrical systems and the load being direct/indirect grounded or floated.

The control module has a microcontroller and a communication interface, where the communication interface both transmits status reports for the marine water electrolysis system and also receives data input for the microcontroller. The power module communicates with the control module. The power module is divided into sub-modules, referred to herein as the first rectifier sub-module and the second rectifier sub-module. The first rectifier sub-module and the second rectifier sub-module have an output of a first current having a first polarity. The power supply is used in combination with an electrolyzer having an anode and a cathode conductively connected to the first rectifier sub-module and the second rectifier sub-module to receive the first current. The microcontroller provides instructions to the power module to provide a specified DC voltage and a specified DC current to the electrolyzer according to the data input.

Data input to the control module through the communication interface may be either provided by digital keypad or through a remote access panel.

The sub-modules may be identical, with each sub-module capable of independent operation (at different voltage and current levels). A number of power modules can be connected in series or in parallel to match the DC voltage and DC current requirements of the electrolyzer. The sub-modules may be stacked in a tower configuration within a rack. The module tower may be water cooled to protect the modules from overheating. Any one or more power modules may be removed from the rack independent of the remaining power modules within the. Vibration dampers may be attached to both the top and bottom of the rack making embodiments of the disclosed power supply more reliable in the marine environment. As can be appreciated, the marine environment can be harsh given the potential vibration and extreme weather changes. Embodiments of the present invention are configured to endure these conditions and provide reliable service.

Impurities which were not filtered out before the ballast water is introduced into the electrolyzer (as well as various kinds of salts which are byproducts of the electrolysis reaction) are likely to stick to the electrodes of the electrolyzer. The impurities sticking to the electrodes may cause damage to the electrodes and become a factor of lowering efficiency of sterilizing polluted water. Therefore, it would be useful if the electrodes could be periodically cleaned. Embodiments of the present invention provide for the periodic cleaning of the electrodes by further comprising an electronic polarity reverse module which reverses the polarities of the rectifiers automatically. The reversal may occur electronically according to a preset timing, or upon receipt of instructions from the microcontroller without the need to physically switch the connections from the rectifiers to the electrolyzer. This feature provides a convenient and automatic way of cleaning the electrodes.

### BRIEF DESCRIPTION OF THE DRAWINGS

FIG. 1 depicts an embodiment of the power supply for a marine water electrolysis system, shown in a towered configuration with vibration dampeners at the top and bottom of the tower.

FIG. 2 is a partially-exploded view of the embodiment depicted in FIG. 1.

FIG. 3 is a block diagram showing the various components of embodiments of the power supply and the communication paths between the components.

FIG. 4 is a block schematic showing the configuration of the control module, power modules, DC busbar and polarity reverse unit.

FIG. 5 is a block schematic of a control module.

FIG. 6 is a block schematic of a power module, showing the two submodules.

FIG. 7 depicts an embodiment of the power supply for a marine water electrolysis system secured by a support structure.

FIG. 8 depicts a side view of the embodiment depicted in FIG. 7.

FIG. 9 depicts a front view of the embodiment depicted in FIG. 8.

### DETAILED DESCRIPTION OF THE INVENTION

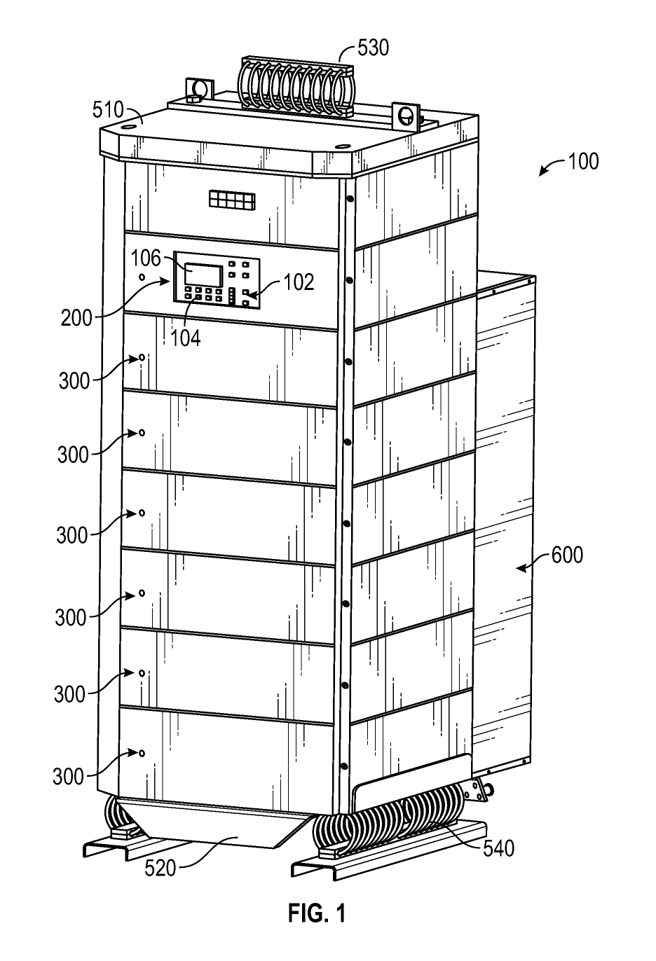

Referring now to the Figures, FIG. 1 shows an embodiment of the disclosed power supply 100 in a tower configuration. The power supply 100 has a control module 200 and one or more power modules 300. The control module 200 may have an exterior accessible interface 102 having a digital keypad 104 and a visual display 106. The control module 200 may also be controlled by the user using remote, digital or analog communication using industry standard communication protocols

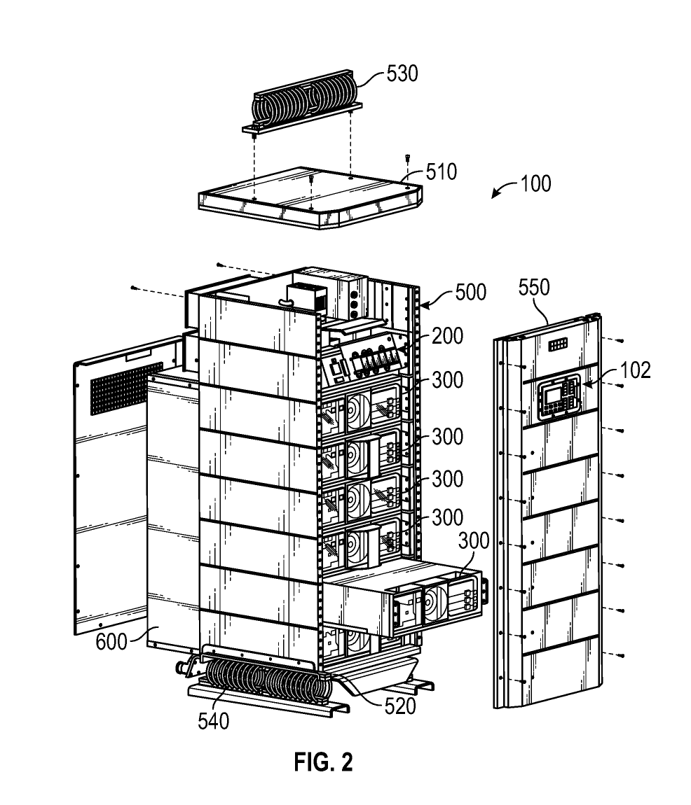

As shown in greater detail in the partially exploded view of FIG. 2, power supply 100 may have a control module 200 and a plurality of power modules 300 which are slidably and removably installed within a rack 500. Rack 500 has a top 510 and a bottom 520. For mounting the power supply 100 securely within a marine vessel but providing for sea-induced motion, the power supply 100 may utilize an upper vibration dampener 530 mounted to the top 510 and a lower vibration dampener 540 mounted to the bottom 520 of the rack 500. Rack 500 may further comprise a front panel 550 which secures the various modules at the front within the rack. The power supply 100 may further comprise an adjacent cooling unit 600 which may have an internal heat exchange unit which may utilize water or other coolant and cooling fans. As shown in FIG. 2, cooling unit 600 may be secured at the rear of the power supply 100.

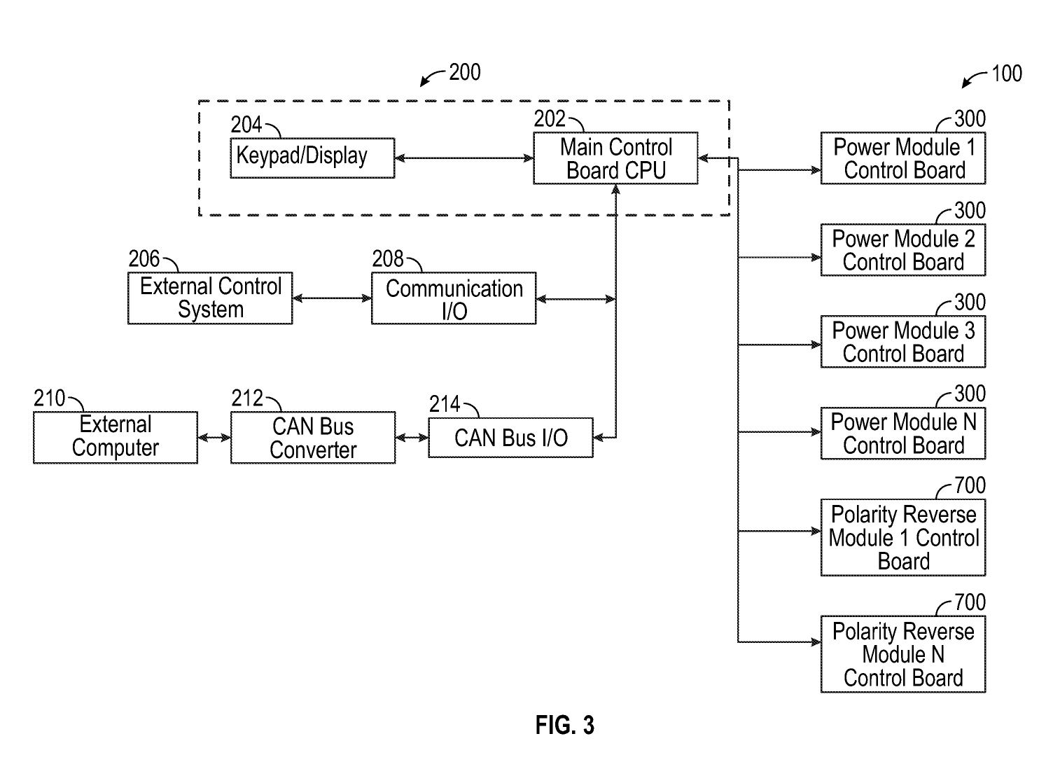

FIG. 3 schematically shows a generalized configuration of the communication paths between the components of the power supply 100. As indicated in FIG. 3, the control module 200 may comprise a central processing unit (CPU) or microcontroller 202 with an integral user interface 204 having a keypad and display. Control module 200 may receive instructions remotely via an external control system 206 through a communication portal 208 and/or through an external computer 210 having access through a controller area network bus converter 212 and input-output module 214. As further indicated in FIG. 3, control module 200 may communicate with multiple power modules 300, as well as multiple polarity reverse modules 700. This configuration allows local and remote access, control and monitoring of the various components and operating status of the power supply 100.

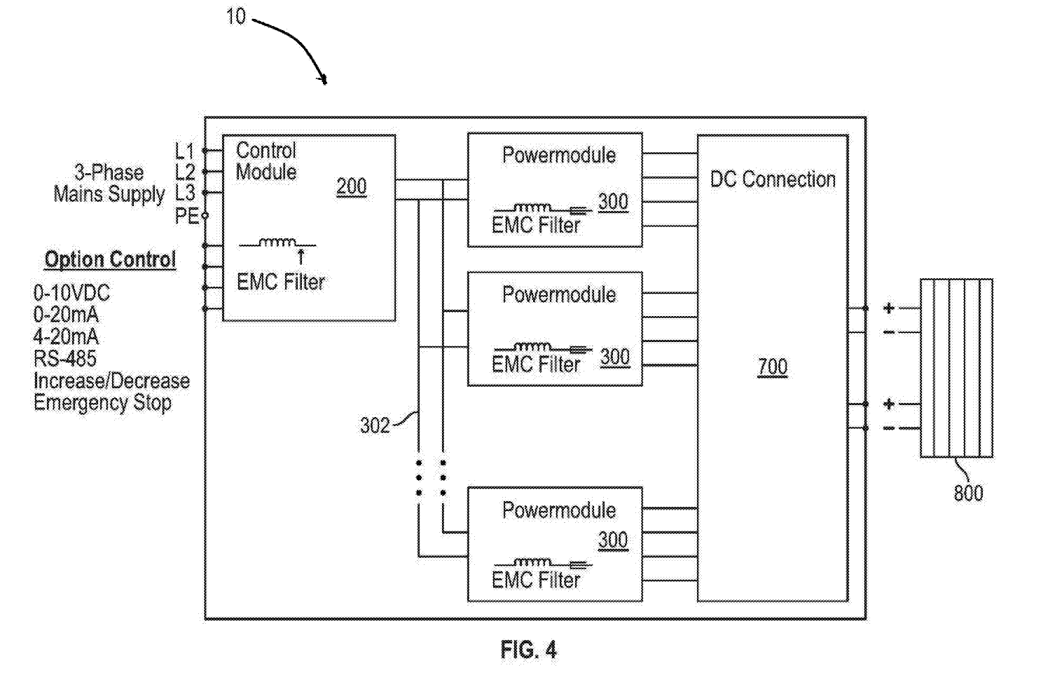

FIG. 4 schematically depicts a configuration of control module 200, power modules 300, and polarity reverse module 700 and associated DC busbar connected to electrolyzer 800. Three phase current and ground (PE) are connected via bus bar to control module 200. As further indicated in FIG. 4, control module 200 may be controlled, optionally, by a variety of analog and digital I/O, including 0-10 VDC, 0-20 mA, 4-20 mA, RS-485, increase-decrease feedback controls, and may also include a dedicated emergency stop. Power modules 300 are inter-connected via a power and control bus 302. As indicated in FIG. 4, the control module 200 and power modules may be equipped with EMC filters.

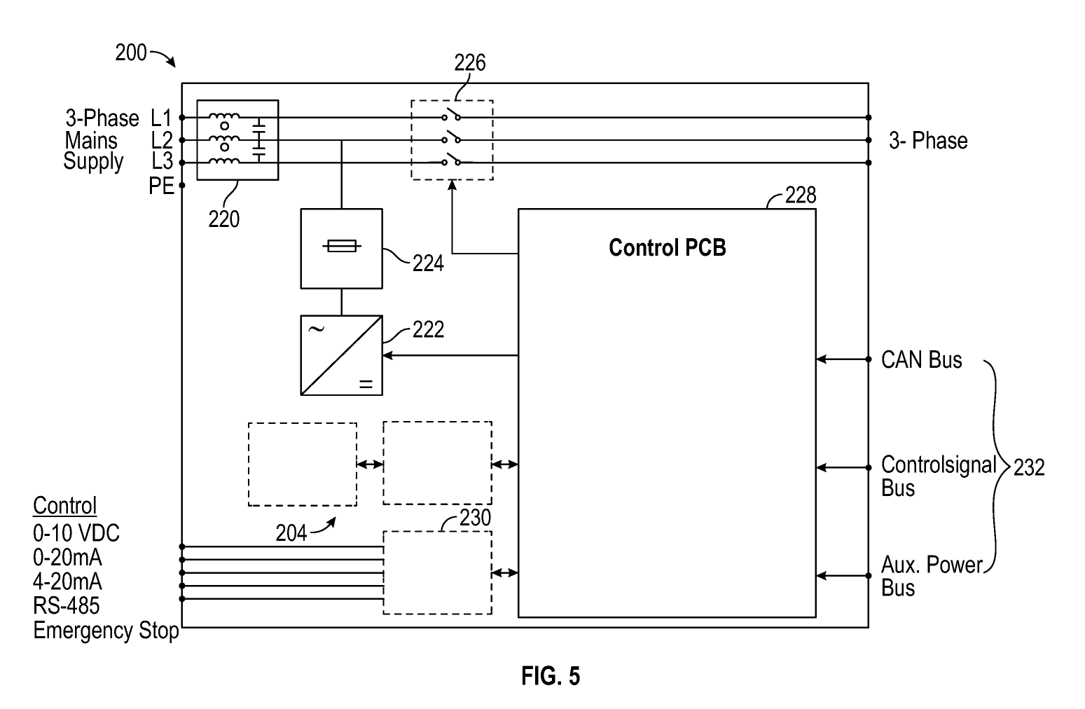

FIG. 5 schematically depicts an embodiment of control module 200. The control module 200 may comprise an EMC filter 220, a 24 VDC power supply 222 connected via fuses 224, and optional contactor module 226. Control circuit board 228 connected to current and control signals via I/O circuit board 230 and multiple busbars (collectively 232). As discussed above, localized control and monitoring may be provided via integral user interface 204.

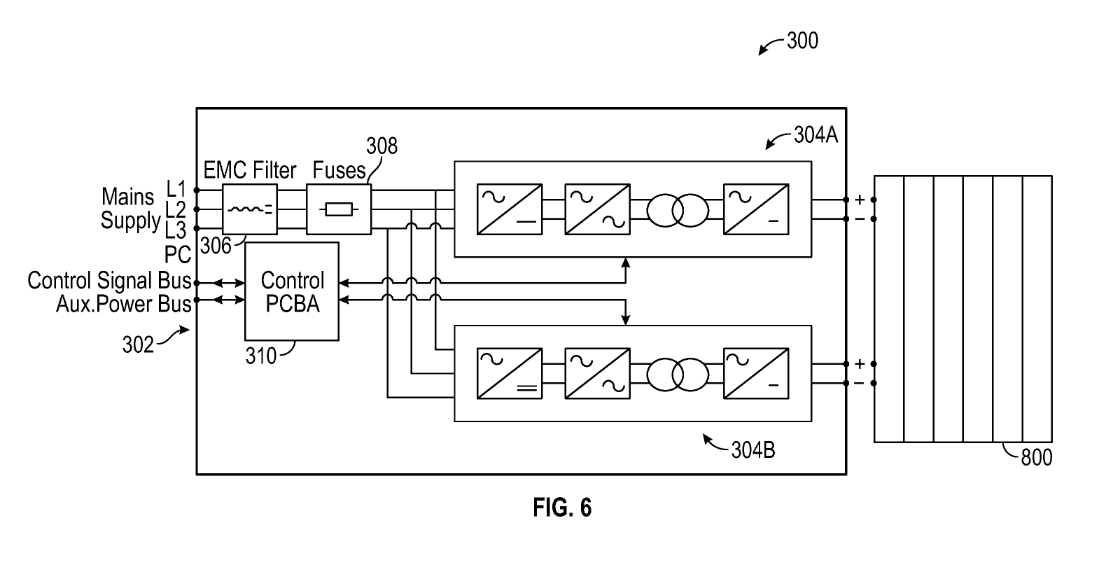

FIG. 6 schematically depicts a power module 300 comprising rectifier submodule 304A and rectifier submodule 304B, where rectifier submodule 304A and rectifier submodule 304B each have a direct current output of the same polarity provided to electrolyzer 800. Three phase current is provided to power module 300 via power and control bus 302, as depicted in FIG. 4, flowing through EMC filter 306 and protective fuses 308. Control bus 302 further provides and receives control and monitoring signals processed through control circuit board 310. The control signals will control the DC voltage out and current provided to electrolyzer 800 and will allow monitoring of the same. As shown in FIG. 3, embodiments of the power supply may include reverse polarity modules 700 which reverse the polarity of the direct current output of rectifier submodule 304A and rectifier submodule 304B. The reversal may be according to preset timing, or upon receipt of specific instructions received via control circuit board 310.

The sub-modules may be identical, with each sub-module capable of independent operation (at different voltage and current levels). It is to be appreciated that FIG. 6 shows a single power module 300. However, embodiments of the power supply 100 may comprise multiple power modules 300, as indicated in FIGS. 3-4. Any number of power modules 300 can be connected in series or in parallel to match the DC voltage and DC current requirements of the electrolyzer 800.

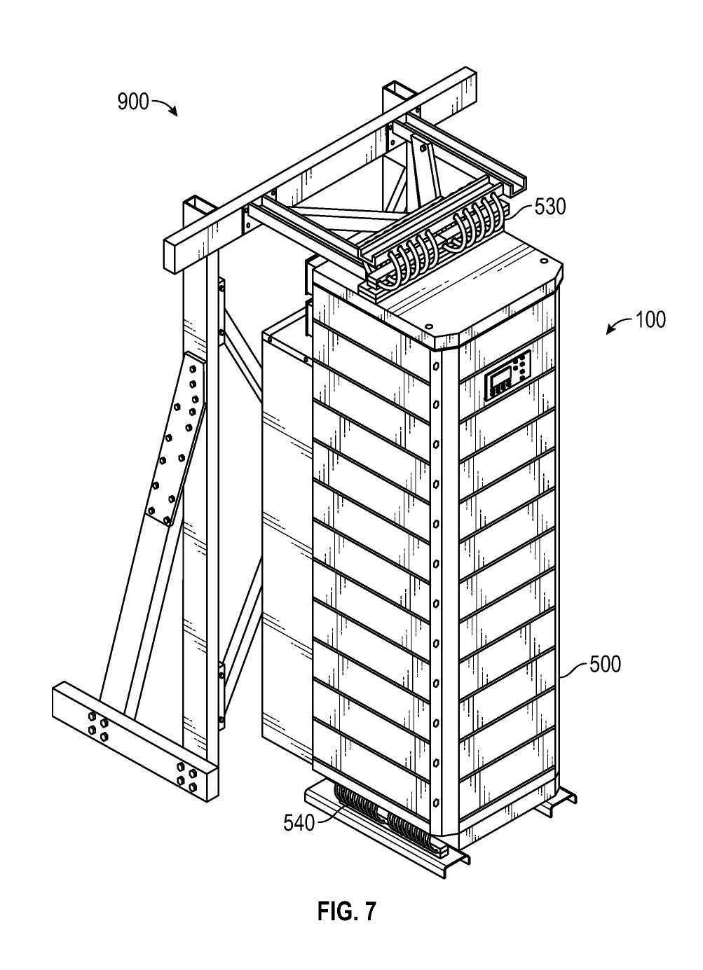

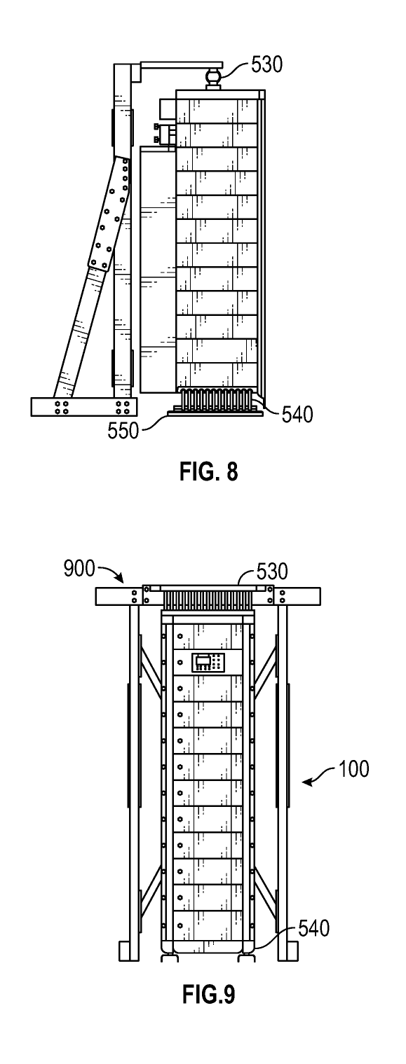

FIGS. 7-9 depict embodiments of the power supply 100 installed within a rack 500 and secured by support structure 900. Top 510 of the rack 500 is secured to support structure 900 by upper vibration dampener 530. Lower vibration dampener 540 is disposed between the bottom 520 of rack 500 and the deck 550 of the vessel.

Having thus described embodiments of the invention, what is claimed as new and desired to be protected by Letters Patent includes the following:

1. A marine water electrolysis system comprising:
an electrolyzer having an anode and a cathode conductively connected to a first rectifier sub-module and to a second rectifier sub-module in receive a first direct current; and
a power supply comprising: a control module connected to an alternating current source, the control module comprising a microcontroller, the control module having a communication interface for transmitting a status report of the marine water electrolysis system and for receiving data input for the microcontroller; a power module communicating with the control module, the control module providing a flow of alternating current to the power module, the power module comprising the first rectifier sub-module and the second rectifier sub-module, the first rectifier submodule and the second rectifier sub-module having an output of the first direct current, wherein the first direct current has a first polarity;
wherein the microcontroller provides instructions to the power module lo provide a specified DC voltage and a specified DC Current to the electrolyzer according to the data input.

2. The marine water electrolysis system of claim 1 wherein the data input is provided through a digital keypad.

3. The marine water electrolysis system of claim 1 wherein the data input is provided through a remote access portal.

4. The marine water electrolysis system of claim 1 wherein the first rectifier sub-module provides a different DC output voltage and a different DC output current than the second rectifier sub-module.

5. The marine water electrolysis system of claim 1 wherein the power supply comprises a plurality of at least three power modules.

6. The marine water electrolysis system of claim 5 wherein the control module and the plurality of power modules are stacked in a tower configuration in a rack.

7. The marine water electrolysis system of claim 5 wherein the plurality of power modules are connected in series to match a DC voltage requirement of the electrolyzer.

8. The marine water electrolysis system of claim 5 wherein the plurality of power modules are connected in parallel to match a DC current requirement of the electrolyzer.

9. The marine water electrolysis system of claim 6 wherein any one or more power modules of the plurality of power modules may be removed from the rack independent of the remaining plurality of power modules.

10. The marine water electrolysis system of claim 6 wherein the rack comprises a top and a bottom, and the top comprises an upper vibration damper and the bottom comprises a lower vibration damper.

11. The marine water electrolysis system of claim 1 further comprising an electronic polarity reverse module conductively disposed between the power module and the electrolyzer wherein the electronic polarity reversal module reverses the first polarity.

12. The marine water electrolysis system of claim 11 wherein the electronic polarity reverse module comprises a preset timer which reverses the first polarity at a user specified time interval.

13. The marine water electrolysis system of claim 11 wherein the electronic polarity reverse module reverses the first polarity upon receiving instructions from the microcontroller.

14. A marine water electrolysis system, the power supply comprising:
an electrolyzer having an anode and a cathode connected to a first busbar to receive a first positive direct current and a first negative direct current;
a power supply comprising: a control module connected to an alternating current source, the control module comprising a microcontroller, the control module having a communication interface for transmitting a status report of the marine water electrolysis system and for receiving data input for the microcontroller; a plurality of at least three interconnected power modules, each of the interconnected power modules receiving a flow of alternating current from the control module, each of the interconnected power modules comprising a first rectifier sub-module and a second rectifier sub-module, each of the first rectifier sub-modules and the second sub-module rectifiers having an output to the first busbar, the output having a first polarity comprising the first positive direct current and the first negative direct current; and
a rack wherein the control module and the plurality of interconnected power modules are stacked in a tower configuration;
wherein the microcontroller provides instructions to the plurality of interconnected power modules to provide a specified DC voltage and a specified DC current to the electrolyzer according to the data input.

15. The marine water electrolysis system of claim 14 wherein the data input is provided through a digital keypad.

16. The marine water electrolysis system of claim 14 wherein the data input is provided through a remote access portal.

17. The marine water electrolysis system of claim 14 wherein the rack comprises a top and a bottom, and the top comprises an upper vibration damper and the bottom comprises a lower vibration damper.

18. The marine water electrolysis system of claim 14 further comprising an electronic polarity reverse module conductively disposed between the plurality of interconnected power modules and the electrolyzer wherein the electronic polarity reversal module reverses the first polarity.

19. The marine water electrolysis system of claim 18 wherein the electronic polarity reverse module comprises a preset timer which reverses the first polarity at a user specified time interval.

20. The marine water electrolysis system of claim 18 wherein the electronic polarity reverse module reverses the first polarity upon receiving instructions from the microcontroller.

21. The marine water electrolysis system of claim 14 wherein the plurality of interconnected power modules are connected in series to match a DC voltage requirement and a DC current requirement of the electrolyzer.

22. The marine water electrolysis system of claim 14 wherein the plurality of interconnected power modules are connected in parallel to match a DC voltage requirement and a DC current requirement of the electrolyzer.

23. The marine water electrolysis system of claim 14 wherein any one of the interconnected power modules of the plurality of interconnected power modules may be removed from the rack independently of the remaining plurality of power modules.

24. The marine water electrolysis system of claim 1 wherein the power module comprises a single housing containing the first rectifier sub-module and the second rectifier sub-module, wherein the control module and the power module are stacked in a tower configuration in a rack.

25. The marine water electrolysis system of claim 14 wherein each of the power modules of the at least three interconnected power modules comprises a single housing containing the first rectifier sub-module and the second rectifier sub-module.
